(19) United States
(12) Patent Application Publication
(10) Pub. No.: US 2025/0265309 A1
(43) Pub. Date: Aug. 21, 2025

(54) SYSTEMS AND METHODS FOR IDENTIFYING ADJUSTABLE DATA RECORDS TO BE AUDITED

(71) Applicant: SAP SE, Walldorf (DE)

(72) Inventor: Jan SCHRAGE, Helmstadt-Bargen (DE)

(21) Appl. No.: 18/582,426

(22) Filed: Feb. 20, 2024

(51) Int. Cl. G06F 17/18; G06F 7/08

(52) U.S. Cl. CPC G06F 17/18; G06F 7/08

(57) ABSTRACT

Embodiments describe techniques for identifying candidates for a value increase audit. The techniques described apply regression models to identify and correct for systemic drift in adjustable data records. In some embodiments, the result is an approximate normal distribution of variations from 0 which allows the use of statistical tools such as standard deviation.

### BACKGROUND

Many companies today have standard auditing and compliance processes which may include an audit when data records increase in value. A data record audit is an audit performed by an auditor to determine whether a value increase for a particular data record is warranted. Generally, the auditing tool may recommend candidates for a data record audit when the value has increased above a certain percentage, for example 10%. However, auditing is a very manual process and therefore an auditor only has time to perform a limited number of audits. Therefore, there is a need for better tools to identify the best candidates to audit.

### BRIEF DESCRIPTION OF THE DRAWINGS

FIG. 1 illustrates a system for identifying candidates for data record audits according to some embodiments.

FIG. 2 illustrates an exemplary graph plotting an employee compensation dataset and a linear regression line according to some embodiments.

FIG. 3 illustrates an exemplary graph plotting an employee compensation dataset and a linear regression line on salaries that has been converted to percentages according to some embodiments.

FIG. 4 illustrates an exemplary graph plotting an employee compensation dataset and a plurality of standard deviation lines according to some embodiments.

FIG. 5 illustrates a workflow for identifying candidates for audit according to some embodiments.

FIG. 6 depicts a simplified block diagram of an example computer system 600, which can be used to implement some of the techniques described in the foregoing disclosure.

### DETAILED DESCRIPTION

Described herein are methods and apparatuses to identify candidates for adjustable data record audits that utilize regression modeling. In some embodiments, regression models may be applied to identify and correct for systemic drift to adjustable data records before audits. An adjustable data record is one where values in the data record may be changed, either manually or based on one or more manual inputs to an algorithm. Herein, data record and adjustable data record are being used interchangeably. Systemic drift may be caused by a change in a significant number of values in adjustable data records due to various factors. In one example, the value in a data record is employee compensation and causes of systemic drift include employee bonuses, stock grants, and other types of one-time payments received from the company. When the systemic drift is significant, the employee compensation may see a significant increase which may result in an audit being triggered for the data record. This is a common issue especially for employees with a lower base salary since any one-time payments received would constitute a larger percentage increase in total salary when compared to employees with a higher base salary. If only a single employee gets such an increase, it is a real audit case. If a large number of employees get such an increase at the same time it may distort percentage-based audits. Unfortunately, this may lead to over-auditing certain parts of the population while missing actual outliers. In some embodiments, a linear regression model may be applied to a adjustable dataset to generate a linear regression equation that models the adjustable dataset. The linear regression equation may compare the relationship between an old value of the adjustable data records and a new value of the adjustable data records. The linear regression equation can be represented as a linear regression line in a 2D-graph where the old value of the adjustable data record is on the x-axis and the new value of the adjustable data record new salary is on the y-axis. Data records having a value that is far from the linear regression line are known as outliers and represent ideal candidates for audit. By measuring the distance the value of the adjustable data record is from the linear regression line, systemic drift can be corrected for. In some embodiments, the auditor tool normalizes the data to a mean deviation of 0 by converting the data point and the linear regression equation to relative increases (y=y/x) and subtracting the relative increase of the linear regression equation from the relative increase of the data point. This can result in an approximate normal distribution of variations from 0 which allows the use of statistical tools such as standard deviation.

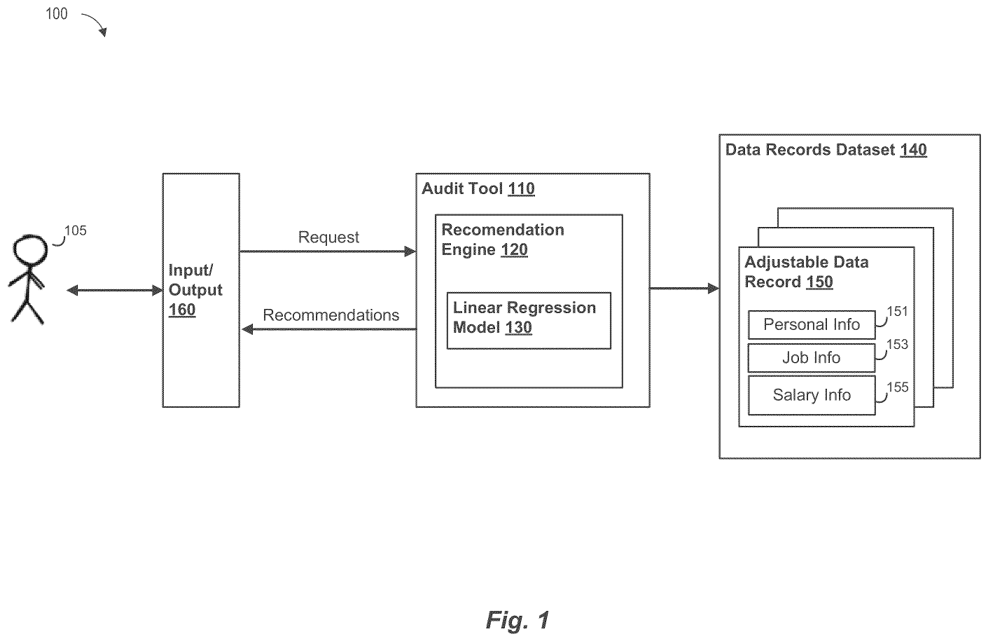

FIG. 1 illustrates a system for identifying candidates for data record according to some embodiments. As shown, system 100 includes auditor 105, audit tool 110, employee compensation dataset 140 and input/output 160. Employee compensation dataset 140 may be stored in a database accessible by audit tool 110. Audit tool 110 may be implemented as software stored in computer readable medium that is executable by a processor. The processor may be a part of a client system or a server system. Adjustable dataset 140 may be stored in memory or a file storage subsystem. Adjustable dataset 140 includes adjustable data record 150. Adjustable data record 150 contains a value that may be adjusted manually or through an algorithm. In one example, the adjustable data record 150 contains information related to an employee of the company. The information can include personal information 151, job information 153, and salary information 155. In other embodiments, more or less information can be included in adjustable data record 150. Employee compensation dataset 140 may include an employee record for every employee in the dataset. Audit tool 110 may be configured as a software tool that auditor 105 utilizes as he or she audits company employees. Audit tool 110 includes recommendation engine 120 that is configured to analyze employee compensation dataset 140 and recommend employees within employee compensation dataset 140 for a salary increase audit. Recommendation engine 120 may apply linear regression model 130 during the analysis to correct for systemic drift.

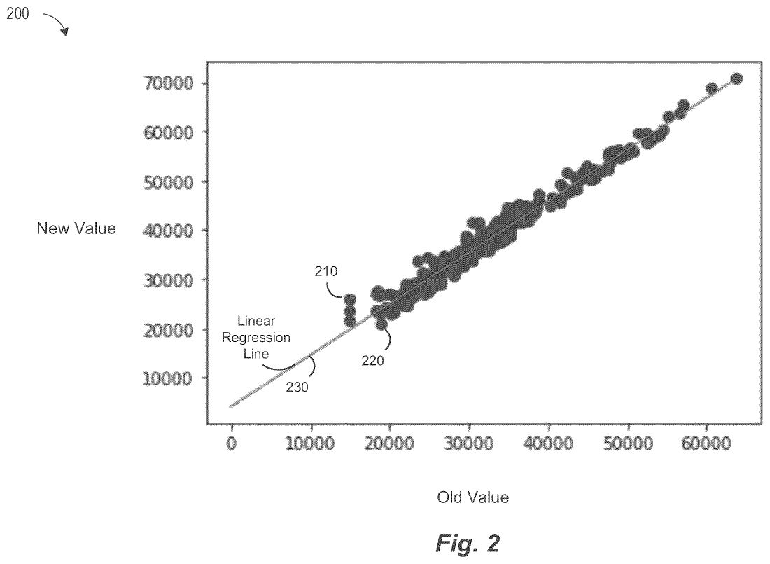

FIG. 2 illustrates an exemplary graph plotting a adjustable dataset and a linear regression line according to some embodiments. Graph 200 may be generated by the audit tool to graphically illustrate the adjustable dataset to the auditor. However, the audit tool does not need to generate graph 200 to identify candidates for audit. Each dot in graph 200 represents a data point which represents an adjustable data record. In one example related to employee compensation, each dot is a data record which represents an employee record in an employee compensation dataset. As shown in graph 200, each data point's position in the graph is dependent on an old value for the adjustable data record and a new value for the adjustable data record. The recommendation engine or the audit tool may normalize the adjustable dataset so that all data records are can be compared with one another. In the example related to employee compensation, the dataset can be normalized such that all data points are based on a fixed hour work week. A fixed hour work week means that all salaries within the data record are normalized to the same number of hours per week. For example, let's assume employee A has an old salary of $10 k for working 20 hours per week while employee B has an old salary of $10 k for working 10 hours per week. If the employee compensation dataset (which includes employees A and B) is to be normalized to a 40 hour work week, then employee A's old salary is normalized from $10 k for 20 hours per week to $20 k for 40 hours per week. Similarly, employee B's old salary is normalized from $10 k for 10 hours per week to $40 k for 40 hours per week. Normalization based on a fixed hour work week allows the audit tool to compare employee salaries in a similar format. This may be advantageous since the data would be easier to interpret and use. The recommendation engine may apply a linear regression model on the data points to generate a linear regression equation. The linear regression equation may model some or all of the data points in graph 200. In one embodiment, the linear regression model may be with standard deviation. In another embodiment, the linear regression model may be Huber regression model which is a linear regression model that gives less weight to outliers. Here, the linear regression equation is represented in graph 200 as linear regression line 230. Linear regression line 230 may represent the mean value increase. Data point 210 is above linear regression line 230 so therefore it can be inferred that data record that is represented by data point 210 has a value increase that is greater than the mean. Similarly, data point 230 is below linear regression line 230 so therefore it can be inferred that data record that is represented by data record 220 has a value increase that is less than the mean.

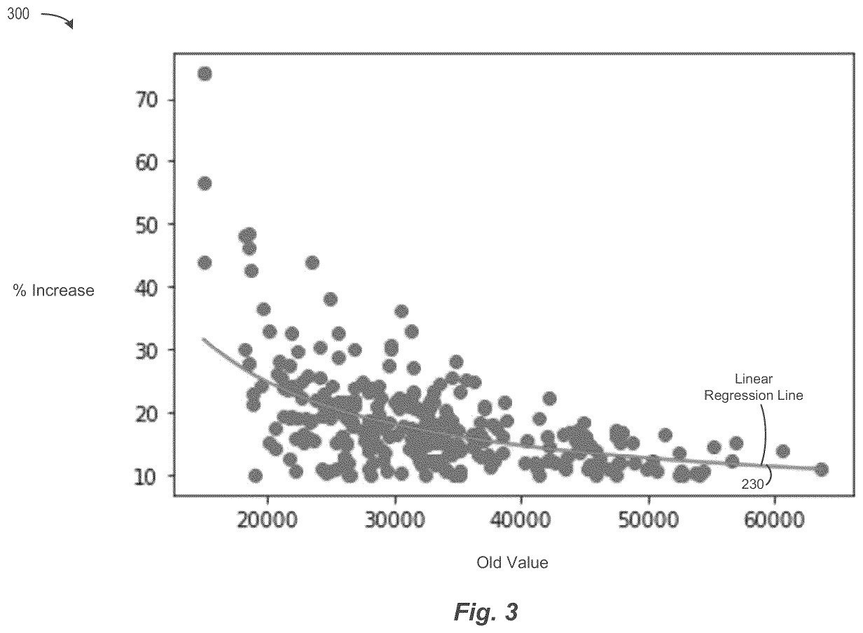

FIG. 3 illustrates an exemplary graph plotting an adjustable dataset and a linear regression line on values that has been converted to percentages according to some embodiments. Graph 300 may be generated by the audit tool to graphically illustrate the adjustable dataset to the auditor. However, the audit tool does not need to generate graph 300 to identify candidates for audit. Each dot in graph 300 is a data point which represents an adjustable data record in a adjustable dataset. As shown in graph 300, each data point's position in the graph is dependent on the old value and the new value as represented as a percentage increase over the old value. This is in contrast to graph 200 of FIG. 2 which illustrates the data points as new value versus old value. The data points are simply shifted in FIG. 3 to account for the change in the y-axis measurement. As shown, the linear regression line 230 which is a straight line from FIG. 2 is now a curved line in FIG. 3. In general, it may be desirable to audit relative increases because the same value increase for a data record with a low value is different than the same value increase for a data record with a high value. In the example of employee compensation, a $10 k increase for an employee who earns $10 k salary is not the same as another employee who earns $100 k with a $10 k increase. In one embodiment, the audit tool may identify or select data points for audit where the percentage increase over the old value is greater than a threshold. For example, the audit tool may identify all adjustable data records that have received over a 20% increase from their old value as audit candidates. This technique, however, has disadvantages such as the inability to account for systemic effects. If such effects are present in the adjustable dataset, this may lead to over-auditing of certain parts of the dataset while missing actual outliers. The underlying assumption is that x % has the same meaning in each value, e.g. the distribution over the salary range retains the same mean. That may not always be the case.

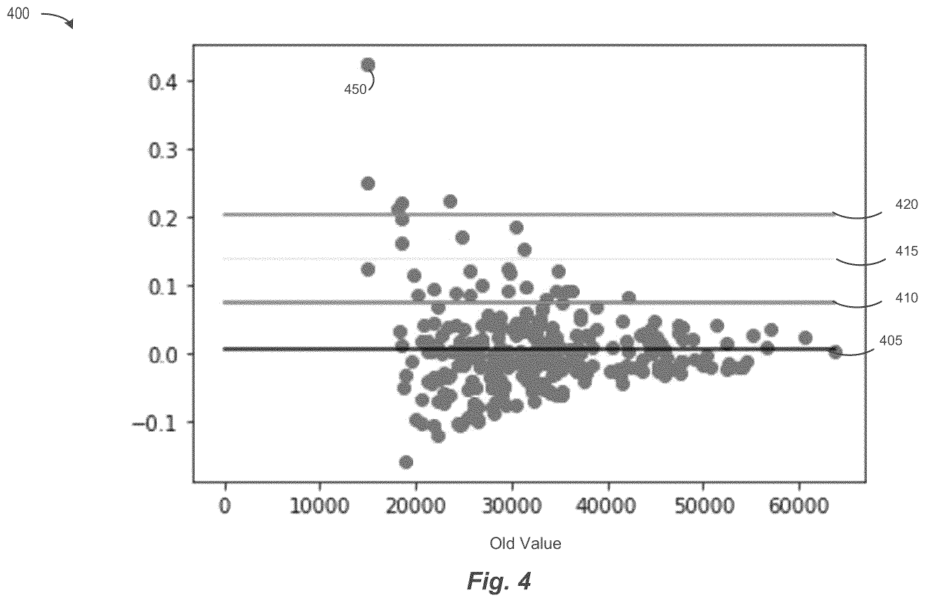

FIG. 4 illustrates an exemplary graph plotting an adjustable dataset and a plurality of standard deviation lines according to some embodiments. Graph 400 may be generated by the audit tool to graphically illustrate the adjustable dataset to the auditor but the audit tool does not need to generate graph 400 to identify candidates for audit. The auditor may select candidate for audit based on the location of the data points in comparison to the standard deviation lines. Each dot in graph 400 is a data point which represents a data record in a adjustable dataset and compares the old value of the data record and how far the percentage increase in value is from the linear regression line. The farther away the value is from zero, the further away the percentage value increase (or decrease) of the value in the data record is from the mean. As shown here, line 405 represents the linear regression line after transformation of the dataset to a mean value of zero on the y-axis, meaning the transformed linear regression equation now is of value zero. On this transformed data set statistical tools such as standard deviation can be applied. Similarly, line 410 represents one standard deviation, line 415 represents two standard deviation, and line 420 represents three standard deviation. In one embodiment, the audit tool or recommendation engine can identify candidates for audit based on the standard deviation lines. For example, the recommendation engine may return all records related to data points above the third standard deviation line. As another example, the recommendation engine may return all records related to data points that are bounded in between the second standard deviation line and the third standard deviation line.

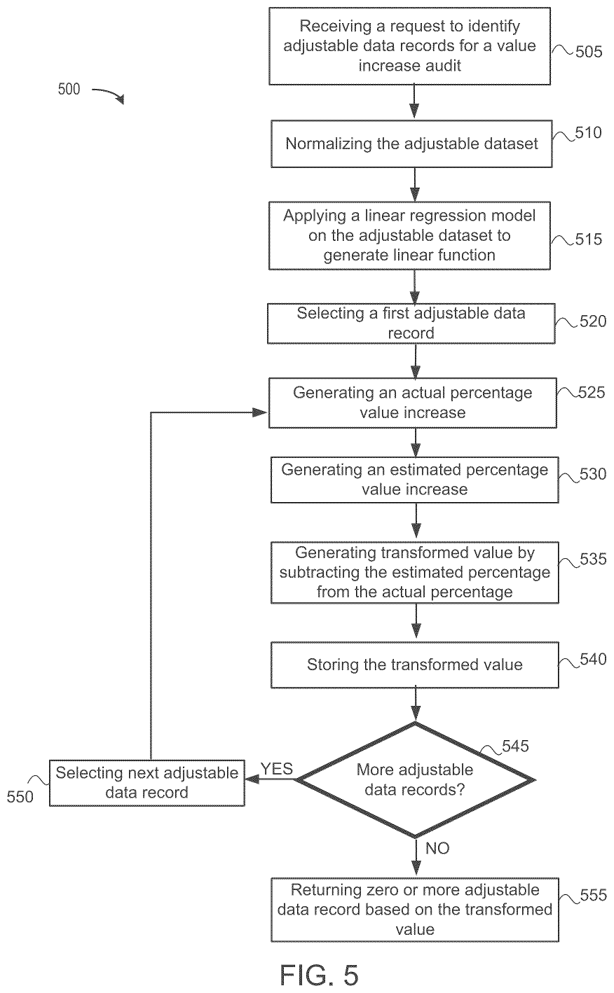

FIG. 5 illustrates a workflow for identifying candidates for audit according to some embodiments. Workflow 500 may be implemented as part of a software program that is stored in computer-readable medium to be executed by a processor. As shown, workflow 500 may begin by receiving a request to identify adjustable data records for a value increase audit at step 505. The adjustable data records may be identified from an adjustable dataset. The adjustable dataset may contain a set of adjustable database records that each may include a unique identifier such as name or ID, an old value, and a new value. In an employee compensation example, the employee's salary (new and old) may include the employee's base salary and one-time payments. The employee's base salary may account for raises received during the time frame between the old salary and the new salary. The one-time payments may include stock grants, bonuses, and cash awards.

Workflow 500 may then continue by retrieving an adjustable dataset from a database at step 510. In some embodiments, the adjustable dataset may be normalized. Normalization of the adjustable dataset may include normalizing the values in each data record. In the example of an employee compensation dataset, the salary values for each data record can be normalized so that they are all based on the same number of hours per work week. This allows the salaries of the employees to be compared with one another easily. In some embodiments, all the values within the adjusted dataset may already be normalized (e.g., all salaries are based on a 40 hour work week) so step 510 may be skipped. In some examples, workflow 500 may also filter the adjusted dataset so that only a subset of the data records in the adjusted dataset is in consideration. The filter may be by company, by country, by group, or by other information stored within the data record.

Workflow 500 may then continue by applying a linear regression model on the adjustable dataset (e.g. employee compensation dataset) to generate a linear function at step 515. The linear function generated, which has a fixed slope and a y-intercept, may be a model that represents the adjusted dataset. In one example, the linear function may be a model that best fits the adjusted dataset, which means that the data records, collectively, are closest to the linear function. The adjusted dataset may be visually represented through a graph such as graph 200 of FIG. 2. The linear function can be graphed as a straight line, also known as the linear regression line. As shown in FIG. 2, linear regression line 230 may be the line that fits best when drawn through the set of data records.

Workflow 500 may then continue by generating a transformed value for each adjustable data record. The transformed value may be utilized during the identification of candidates for value increase audits. Workflow 500 may select the first data record at step 520. For the first data record, workflow 500 starts by generating an actual percentage value increase at step 525. The actual percentage value increase may be calculated by dividing the new value by the old value then subtracting the result by 1. For example in the instance of employee compensation dataset if the new salary is $5500 and the old salary is $5000, then the actual percentage salary increase value is equal to $5500/$5000-1=0.1. The value 0.1 means the new salary is a 10% increase of the old salary. The actual percentage value increase for the set of adjustable data records may be visually represented through a graph such as graph 300 of FIG. 3. As shown in FIG. 3, graph 300 compares the old value of an adjustable data record to the percentage value increase of the adjustable data record. Since the y-axis represents a % increase, the linear regression line is now curved.

For the first adjustable data record, workflow 500 continues by generating an estimated percentage value increase at step 530. The estimated percentage value increase may be generated as a two part process. In the first part, the old value of the first adjustable data record may be input into the linear function that models the adjustable dataset to generate an estimated new value. In the second part, the estimated percentage value increase may be calculated from the estimated new value and the old value in a similar manner that the actual percentage value increase was generated (dividing estimated value by old value and subtracting the result by 1). Workflow 500 then continues by generating the transformed value for the first adjustable data record by subtracting the estimated percentage value increase from the actual percentage value increase at step 535. The transformed value for the set of adjustable data records may be visually represented through a graph such as graph 400 of FIG. 4. As shown in FIG. 4, graph 400 includes line 405 at y-value 0. Data records that are close to line 405 have an estimated percentage value increase that is close to the actual estimated percentage value increase. This means that the salary increase that the employee received is close to the mean salary increase, which implies that the employee is unlikely a good candidate for value increase audit. In contrast, data record 450 is far above line 405. This means that the value increase that the employee represented by data record 405 has received is much higher than the mean salary increase, which implies that the employee is likely a good candidate for a salary increase audit. By applying a linear regression model and normalizing the data with a mean value of zero and normal distribution, systemic drift can be corrected for and thus will little to no impact on the selection of candidates for audit. Once generated, the transformed value may be stored at step 540.

Once the transformed value has been generated and stored for the first adjustable data record, workflow 500 can continue by determining whether there are more adjustable data records to process at step 545. If there are additional adjustable data records to process, workflow 500 continues by selecting the next adjustable data record at step 550. If there are no more additional data records to process, workflow 500 continues by identifying at least data records based on the transformed value at step 555. Based on the parameters, no data records may be identified. In one embodiment, workflow 500 may return a predefined number of data records. Selection of the data records may be based on the transformed value where the data records with a higher transformed value are selected over data records with lower transformed value. In another embodiment, workflow 500 may generate a standard deviation value and return a group of data records having a transformed value greater than the first standard deviation value. In yet another embodiment, workflow 500 may generate multiple standard deviation values and return a group of data records that have a transformed value between two standard deviation values. For example a group of data records that have a transformed value between 1 standard deviation and 2 standard deviation may be returned. In yet another embodiment, a graph similar to graph 400 of FIG. 4 may be presented to the auditor. The auditor may then select a group of data records based on the graph. For example, the auditor may select all data records having a transformed value greater than 3 standard deviations, all data records having a transformed value greater than 2 standard deviations, or all data records having a transformed value greater than 1 standard deviation. Once at least one data record has been identified, it may be returned to the user at step 560

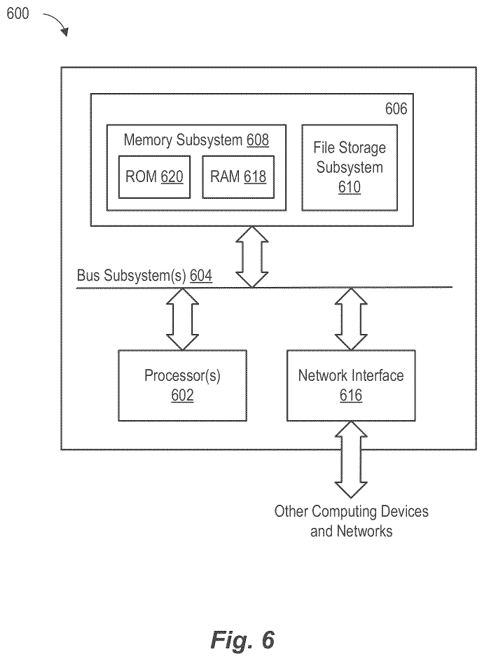

FIG. 6 depicts a simplified block diagram of an example computer system 600, which can be used to implement some of the techniques described in the foregoing disclosure. As shown in FIG. 6, system 600 includes one or more processors 602 that communicate with several devices via one or more bus subsystems 604. These devices may include a storage subsystem 606 (e.g., comprising a memory subsystem 608 and a file storage subsystem 610) and a network interface subsystem 616. Some systems may further include user interface input devices and/or user interface output devices (not shown).

Bus subsystem 604 can provide a mechanism for letting the various components and subsystems of system 600 communicate with each other as intended. Although bus subsystem 604 is shown schematically as a single bus, alternative embodiments of the bus subsystem can utilize multiple buses.

Network interface subsystem 616 can serve as an interface for communicating data between system 600 and other computer systems or networks. Embodiments of network interface subsystem 616 can include, e.g., Ethernet, a Wi-Fi and/or cellular adapter, a modem (telephone, satellite, cable, etc.), and/or the like.

Storage subsystem 606 includes a memory subsystem 708 and a file/disk storage subsystem 610. Subsystems 608 and 610 as well as other memories described herein are examples of non-transitory computer-readable storage media that can store executable program code and/or data that provide the functionality of embodiments of the present disclosure.

Memory subsystem 608 comprise one or more memories including a main random access memory (RAM) 618 for storage of instructions and data during program execution and a read-only memory (ROM) 620 in which fixed instructions are stored. File storage subsystem 610 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 600 is illustrative and many other configurations having more or fewer components than system 600 are possible.

The above description illustrates various embodiments of the present invention along with examples of how aspects of the present invention may be implemented. The above examples and embodiments should not be deemed to be the only embodiments and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

### FURTHER EXAMPLES

Each of the following non-limiting features in the following examples may stand on its own or may be combined in various permutations or combinations with one or more of the other features in the examples below. In various embodiments, the present disclosure may be implemented as a processor or method.

In some embodiments the present disclosure includes a method, comprising receiving a request from a user, the request to identify at least one adjustable data record for a value increase audit; retrieving an adjustable dataset containing a set of adjustable data records from a database, each adjustable data record including a data record identifier, an old data value, and a new data value; applying a linear regression model on the adjustable dataset to generate a linear function that models the adjustable dataset, the linear function having a slope and a y-intercept; for each adjustable data record in the adjustable dataset: generating an actual percentage value increase value for the adjustable data record by dividing the new data value by the old data value; generating an estimated percentage value increase by inputting the old data value to the linear function to calculate an estimated new data value and dividing the estimated new data value by the old data value; subtracting the actual percentage value increase from the estimated percentage value increase to generate the transformed value; and storing the transformed value; identifying the at least one adjustable data record from the adjustable dataset based on the transformed value; and returning the identified at least one adjustable data record to the user.

In one embodiment, the request includes a number of adjustable data records to audit.

In one embodiment, identifying the at least one adjustable data record comprises: sorting the set of adjustable data records according to the transformed value of each adjustable data record; and selecting the number of adjustable data records with the highest transformed value.

In one embodiment, identifying the at least one adjustable data record comprises: generating a standard deviation value; and selecting a group of adjustable data records that have a transformed value greater than the first standard deviation value.

In one embodiment, identifying the at least one adjustable data record comprises: generating a first standard deviation value; generating a second standard deviation value; selecting a first group of adjustable data records that have a transformed value greater than the first standard deviation value; and selecting a second group of adjustable data records that have a transformed value between the first standard deviation value and the second standard deviation value, wherein the first standard deviation value is greater than the second standard deviation value.

In one embodiment, the linear regression model is a Huber regression model.

In one embodiment, the transformed values in the adjustable dataset have a mean value of zero.

In one embodiment, the method further comprises normalizing the adjustable dataset such that the set of adjustable data records are normalized.

In some embodiments the present disclosure includes a system comprising: one or more processors; a non-transitory computer-readable medium storing a program executable by the one or more processors, the program comprising sets of instructions for: receiving a request from a user, the request to identify at least one adjustable data record for a value increase audit; retrieving an adjustable dataset containing a set of adjustable data records from a database, each adjustable data record including a data record identifier, an old data value, and a new data value; applying a linear regression model on the adjustable dataset to generate a linear function that models the adjustable dataset, the linear function having a slope and a y-intercept; for each adjustable data record in the adjustable dataset: generating an actual percentage value increase value for the adjustable data record by dividing the new data value by the old data value; generating an estimated percentage value increase by inputting the old data value to the linear function to calculate an estimated new data value and dividing the estimated new data value by the old data value; subtracting the actual percentage value increase from the estimated percentage value increase to generate the transformed value; and storing the transformed value; identifying the at least one adjustable data record from the adjustable dataset based on the transformed value; and returning the identified at least one adjustable data record to the user.

In some embodiments the present disclosure includes a non-transitory computer-readable medium storing a program executable by one or more processors, the program comprising sets of instructions for: receiving a request from a user, the request to identify at least one adjustable data record for a value increase audit; retrieving an adjustable dataset containing a set of adjustable data records from a database, each adjustable data record including a data record identifier, an old data value, and a new data value; applying a linear regression model on the adjustable dataset to generate a linear function that models the adjustable dataset, the linear function having a slope and a y-intercept; for each adjustable data record in the adjustable dataset: generating an actual percentage value increase value for the adjustable data record by dividing the new data value by the old data value; generating an estimated percentage value increase by inputting the old data value to the linear function to calculate an estimated new data value and dividing the estimated new data value by the old data value; subtracting the actual percentage value increase from the estimated percentage value increase to generate the transformed value; and storing the transformed value; identifying the at least one adjustable data record from the adjustable dataset based on the transformed value; and returning the identified at least one adjustable data record to the user.

What is claimed is:

1. A method, comprising:
receiving a request from a user, the request to identify at least one adjustable data record for a value increase audit;
retrieving an adjustable dataset containing a set of adjustable data records from a database, each adjustable data record including a data record identifier, an old data value, and a new data value;
applying a linear regression model on the adjustable dataset to generate a linear function that models the adjustable dataset, the linear function having a slope and a y-intercept;
for each adjustable data record in the adjustable dataset:
generating an actual percentage value increase value for the adjustable data record by dividing the new data value by the old data value;
generating an estimated percentage value increase by inputting the old data value to the linear function to calculate an estimated new data value and dividing the estimated new data value by the old data value;
subtracting the actual percentage value increase from the estimated percentage value increase to generate the transformed value; and
storing the transformed value;
identifying the at least one adjustable data record from the adjustable dataset based on the transformed value; and
returning the identified at least one adjustable data record to the user.

2. The method as in claim 1, wherein the request includes a number of adjustable data records to audit.

3. The method as in claim 2, wherein identifying the at least one adjustable data record comprises:
sorting the set of adjustable data records according to the transformed value of each adjustable data record; and
selecting the number of adjustable data records with the highest transformed value.

4. The method as in claim 1, wherein identifying the at least one adjustable data record comprises:
generating a standard deviation value; and
selecting a group of adjustable data records that have a transformed value greater than the first standard deviation value.

5. The method as in claim 1, wherein identifying the at least one adjustable data record comprises:
generating a first standard deviation value;
generating a second standard deviation value;
selecting a first group of adjustable data records that have a transformed value greater than the first standard deviation value; and
selecting a second group of adjustable data records that have a transformed value between the first standard deviation value and the second standard deviation value, wherein the first standard deviation value is greater than the second standard deviation value.

6. The method as in claim 1, wherein the linear regression model is a Huber regression model.

7. The method as in claim 1, wherein the transformed values in the adjustable dataset have a mean value of zero.

8. The method as in claim 1, further comprising normalizing the adjustable dataset such that the set of adjustable data records are normalized.

9. A system comprising:
one or more processors;
a non-transitory computer-readable medium storing a program executable by the one or more processors, the program comprising sets of instructions for:
receiving a request from a user, the request to identify at least one adjustable data record for a value increase audit;
retrieving an adjustable dataset containing a set of adjustable data records from a database, each adjustable data record including a data record identifier, an old data value, and a new data value;
applying a linear regression model on the adjustable dataset to generate a linear function that models the adjustable dataset, the linear function having a slope and a y-intercept;
for each adjustable data record in the adjustable dataset:
generating an actual percentage value increase value for the adjustable data record by dividing the new data value by the old data value;
generating an estimated percentage value increase by inputting the old data value to the linear function to calculate an estimated new data value and dividing the estimated new data value by the old data value;
subtracting the actual percentage value increase from the estimated percentage value increase to generate the transformed value; and
storing the transformed value;
identifying the at least one adjustable data record from the adjustable dataset based on the transformed value; and
returning the identified at least one adjustable data record to the user.

10. The system of claim 9, wherein the request includes a number of adjustable data records to audit.

11. The system of claim 10, wherein identifying the at least one adjustable data record comprises:
sorting the set of adjustable data records according to the transformed value of each adjustable data record; and
selecting the number of adjustable data records with the highest transformed value.

12. The system of claim 9, wherein identifying the at least one adjustable data record comprises:
generating a standard deviation value; and
selecting a group of data records that have a transformed value greater than the first standard deviation value.

13. The system of claim 9, wherein identifying the at least one adjustable data record comprises:
generating a first standard deviation value;
generating a second standard deviation value;
selecting a first group of adjustable data records that have a transformed value greater than the first standard deviation value; and
selecting a second group of adjustable data records that have a transformed value between the first standard deviation value and the second standard deviation value, wherein the first standard deviation value is greater than the second standard deviation value.

14. The method as in claim 1, wherein the linear regression model is a Huber regression model.

15. A non-transitory computer-readable medium storing a program executable by one or more processors, the program comprising sets of instructions for:
receiving a request from a user, the request to identify at least one adjustable data record for a value increase audit;
retrieving an adjustable dataset containing a set of adjustable data records from a database, each adjustable data record including a data record identifier, an old data value, and a new data value;
applying a linear regression model on the adjustable dataset to generate a linear function that models the adjustable dataset, the linear function having a slope and a y-intercept;
for each adjustable data record in the adjustable dataset:
generating an actual percentage value increase value for the adjustable data record by dividing the new data value by the old data value;
generating an estimated percentage value increase by inputting the old data value to the linear function to calculate an estimated new data value and dividing the estimated new data value by the old data value;
subtracting the actual percentage value increase from the estimated percentage value increase to generate the transformed value; and
storing the transformed value;
identifying the at least one adjustable data record from the adjustable dataset based on the transformed value; and
returning the identified at least one adjustable data record to the user.

16. The non-transitory computer-readable medium of claim 15, wherein the request includes a number of adjustable data records to audit.

17. The non-transitory computer-readable medium of claim 16, wherein identifying the at least one adjustable data record comprises:
sorting the set of adjustable data records according to the transformed value of each adjustable data record;
selecting the number of adjustable data records with the highest transformed value.

18. The non-transitory computer-readable medium of claim 15, wherein identifying the at least one adjustable data record comprises:
generating a standard deviation value; and
selecting a group of data records that have a transformed value greater than the first standard deviation value.

19. The non-transitory computer-readable medium of claim 15, wherein identifying the at least one adjustable data record comprises:
generating a first standard deviation value;
generating a second standard deviation value;
selecting a first group of adjustable data records that have a transformed value greater than the first standard deviation value; and
selecting a second group of adjustable data records that have a transformed value between the first standard deviation value and the second standard deviation value, wherein the first standard deviation value is greater than the second standard deviation value.

20. The non-transitory computer-readable medium of claim 15, wherein the linear regression model is a Huber regression model.
